(19) United States
(12) Patent Application Publication
(10) Pub. No.: US 2015/0003826 A1
(43) Pub. Date: Jan. 1, 2015

(54) SYSTEM AND METHOD FOR MEASURING DIFFERENTIAL MODE DELAY

(71) Applicants: Nien-Tsu Chiang, Hsinchu (TW); SUCCESS PRIME CORPORATION, MIAO-LI COUNTY (TW)

(72) Inventors: Nien-Tsu Chiang, HSINCHU (TW); Kuei-Huang Chou, MIAO-LI COUNTY (TW)

(21) Appl. No.: 13/929,469

(22) Filed: Jun. 27, 2013

(51) Int. Cl. H04B 10/079; H04B 10/25

(52) U.S. Cl. CPC H04B 10/0795; H04B 10/25
USPC 398/28

(57) ABSTRACT

According to one embodiment of a system for measuring differential mode delay couples with a pulse generator to generate an input electrical pulse, a photo detector to receive optical pulse from an optical fiber, and a digital oscilloscope to receive an output electrical pulse transmitted from the photo detector, the system includes: a laser diode, a first lens and a second lens, a pigtail, and a spliced optical connector, wherein the laser diode receives the input electrical pulse to produce a laser beam, the first lens and the second lens focus the laser beam into the pigtail, the spliced optical connector connects the pigtail and the input end face of the optical fiber such that the optical pulse from the output end face of the optical fiber is received by the photo detector.

### TECHNICAL FIELD

The disclosure generally relates to system and method for measuring differential mode delay.

### BACKGROUND

It has been a great deal of interest in optical local area networks (LAN) operating at speeds of a Giga bit per second (Gbps) or more. An Ethernet standard for such transmission may inevitably function to accelerate the use of high speed optical LAN. For achieving these high rates of optical LANs, semiconductor lasers (such as vertical cavity surface emitting lasers (VCSELs) or Fabry-Perot (FP) lasers) may be used as transmission sources and the multimode fiber (MMF) may be used for optical data transmission. The using of multimode fiber is due to both its ease of installation compared to the single mode fiber (SMF) and the fact that there exits a significantly large embedded base of MMF.

An accepted way to characterize MMF for supporting these higher data rates is with differential mode delay (DMD) measurements. The DMD measurements, for example, as described in detailed in Telecommunication Industry Association (TIA)/Electronic Industries Association (EIA) Standards Document, TIA/EIA 455-220-A, “Differential Mode Delay Measurement of Multimode Fiber in the Time Domain”, dated January 2003, a spatially small (compared to the MMF core) and temporally short optical pulse is launched in the core of the MMF end face that is under test, and at the output end face the resulting pulse is measured. This measurement is repeated, starting at the axis of the MMF core and moving outward to the core/cladding interface. As shown in FIG. 1, due to the cylindrical symmetry of the fiber this linear scan responds to many of the MMF modal structures. The launching spot may originate from a single mode fiber (or equivalent).

FIG. 2 illustrates exemplary system architecture for making DMD measurements. As shown in FIG. 2, a VCSEL source is embedded in a commercially available transceiver, powered by an evaluation board. Voltage pulses from the pulse generator are differentially supplied to the evaluation board and in response the VCSEL generates optical pulses. The pulse width, period, delay, amplitude, and voltage offsets are all controlled from the pulse generator. Optical pulses are launched into SMF from the VCSEL, resulting in pulse attenuation, compared to MMF. The launch SMF is positioned to accuracy and repeatability by the x-y-z precision location control and the bare fiber holder. The MMF under test is located with a bare fiber holder mounted on a stationary fiber holder. The gap between the two fiber end faces is where the DMD offset distances are defined. The axis of the SMF output beam is perpendicular to the end face of the MMF. The launch SMF is positioned at offset launch locations and DMD data are recorded by the scope.

As shown in FIG. 2, positioning axis of the SMF congruently with the axis of the MMF requires a detailed procedure (refer to “Launching spot 1” in FIG. 1). A coarse location is first determined by finding the (horizontal, vertical) edges (x, y) using the optical power meter and the x-y-z precision location control. Based on this estimate of x=0 and y=0, a matrix of measurements is taken with a step size of 5.0 μm for both x and y directions. Numerical methods are used to weight the elements in this array (based on optical power) to determine an accurate measurement of x=0 and y=0.

There are disadvantages in the exemplary system architecture shown in FIG. 2. For example, usually fiber centering procedure takes time and requires high-precision location control which is sensitive to mechanical displacements. Moreover, this centering procedure is needed for every sample of fiber under test. Thus this DMD measurements results in time consuming and high cost for characterizing large fiber samples.

Therefore, a technology for eliminating time-consuming fiber centering procedure in routine measurement, reducing high-cost computer-controlled translation stage, and improving system stability in DMD measurements, is an important issue.

### SUMMARY

The exemplary embodiments of the present disclosure may provide method and apparatus for measuring differential mode delay.

According to one exemplary embodiment of the present disclosure, a system for measuring differential mode delay couples with a pulse generator to generate an input electrical pulse, a photo detector to receive optical pulse from an optical fiber, and a digital oscilloscope to receive an output electrical pulse transmitted from the photo detector, the system includes: a laser diode, a first lens and a second lens, a pigtail, and a spliced optical connector, wherein the laser diode receives the input electrical pulse to generate a laser beam, the first lens and the second lens focus the laser beam into the pigtail, the spliced optical connector connects the pigtail and the input end face of the optical fiber such that the optical pulse from the output end face of the optical fiber is received by the photo detector.

According to another exemplary embodiment of the present disclosure, a method for measuring differential mode delay may use a pulse generator to generate an input electrical pulse, and a digital oscilloscope to receive an output electrical pulse transmitted from an photo detector, the method includes: transmitting the input electrical pulse to a laser diode to produce a laser beam; focusing the laser beam through a first lens and a second lens into a pigtail; transmitting said laser beam within said pigtail connecting the input end face of an optical fiber by a spliced fiber connector such that the optical pulse from the output end face of the optical fiber is received by the photo detector; transmitting the output electrical pulse from the photo detector to the digital oscilloscope; moving the pigtail in linear motion at specific step to launch optical pulses into different modes of the optical fiber; and evaluating DMD through the output electrical pulses received by the digital oscilloscope.

The foregoing and other features, aspects and advantages of the present invention will become better understood from a careful reading of a detailed description provided herein below with appropriate reference to the accompanying drawings.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is an exemplary schematic diagram of the end face of a MMF, showing three idealized launching spots into the core.

FIG. 2 is a system architecture example for making DMD measurements.

FIG. 3 illustrates a schematic diagram of a system for measuring DMD, according to an exemplary embodiment.

FIG. 4 illustrates a schematic diagram of a method for measuring DMD, according to an exemplary embodiment.

### DETAILED DESCRIPTION OF THE EXEMPLARY EMBODIMENTS

Below, exemplary embodiments will be described in detail with reference to accompanying drawings so as to be easily realized by a person having ordinary knowledge in the art. The inventive concept may be embodied in various forms without being limited to the exemplary embodiments set forth herein. Descriptions of well-known parts are omitted for clarity, and like reference numerals refer to like elements throughout.

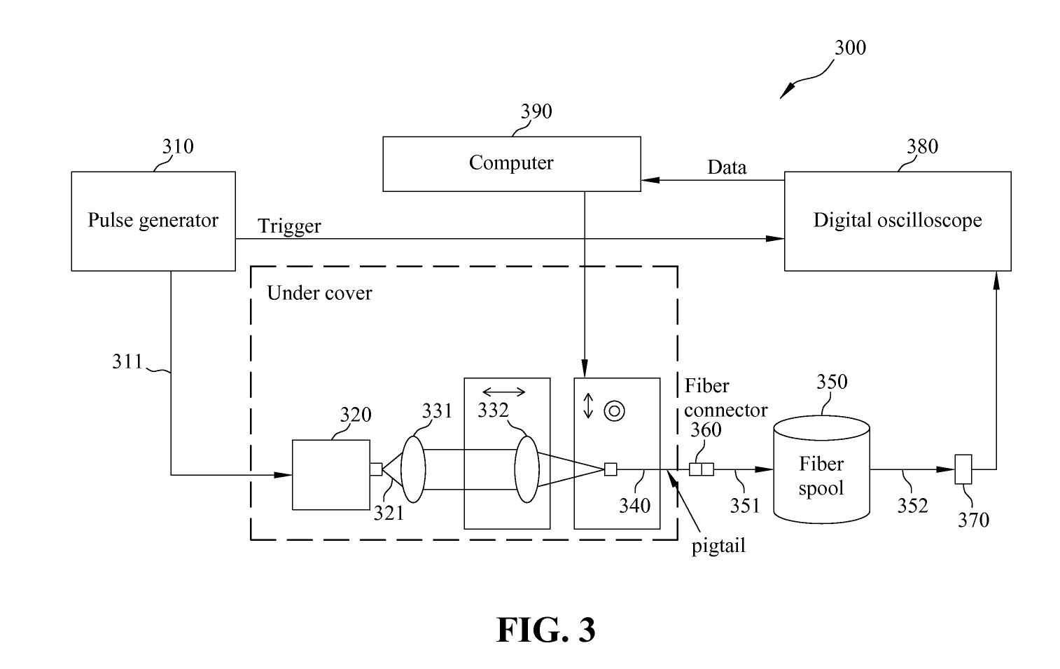

The exemplary embodiment of technology for measuring differential mode delay (DMD) uses two lenses focusing single launch laser beam into a pigtail to connect a MMF under test through a spliced connector in order to make DMD measurement. FIG. 3 illustrates a schematic diagram of a system for measuring DMD, according to an exemplary embodiment.

As shown in the DMD measurement system 300 of FIG. 3, a pulse generator 310 generates an input electrical pulse 311 to a laser diode 320 to produce laser beam 321. Then the laser beam 321 outputted from the laser diode 320 is re-focused by a first lens 331 and a second lens 332 into a pigtail 340. The input end face 351 of an optical fiber under test 350 (such as a MMF) in a fiber spool connects the pigtail 340 through a fiber connector 360 to receive optical pulse within the pigtail 350. A photo detector 370 connects the output end face 352 of the optical fiber under test 350 to convert the optical pulse outputted from the output end face 352 of the optical fiber 350 to an output electrical pulse. The output electrical pulse is then transmitted to a digital oscilloscope 380.

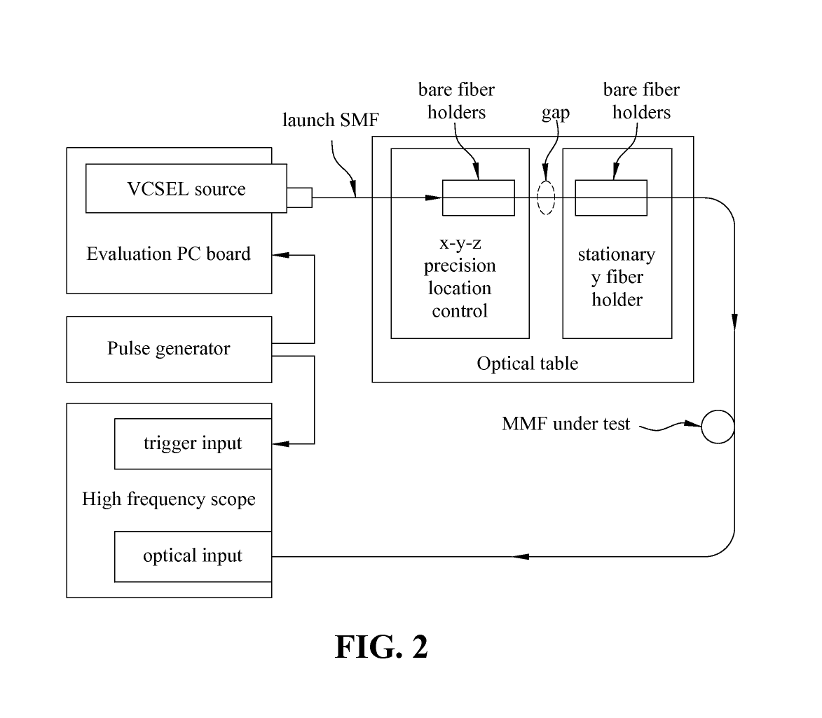

According to the exemplary embodiment shown in FIG. 3, the laser diode 320 outputting laser beam 321 is such as fiber coupled laser diode or free space type, which is able to launch single mode, the pigtail 340 for receiving focused laser beam may use such as patch cord, etc. In FIG. 3, the first lens 331 and the second lens 332 are used for focusing the laser beam into the pigtail and are movable on z-axis with z-axis precision location control, i.e., either one of the first lens 331 and the second lens 332 may move away or toward the other to adjust the distance between the first lens 331 and the second lens 332. The pigtail 340 may also be movable to be preliminary centered on x, y axis, i.e., centered on the input end face 361 of the optical fiber with x, y axis precision location control. These precision location controls for both the pigtail 340 and one of the lenses are performed one time at each system installation, and are accomplished by manual or auto manner. Thus (x, y, z) precision location control procedure is not required for each routine measurement of fiber sample. Therefore the exemplary DMD measurement system of the present invention is much simpler than the DMD measurement system in FIG. 2, wherein (x, y, z) location control is required for each routine measurement of fiber sample. However, the core size of the pigtail 340 is larger than the core size of the optical fiber under test 350 in order to compensate the misalignment of the core center of the pigtail 340 and the fiber under test 350 at the fiber connector 360.

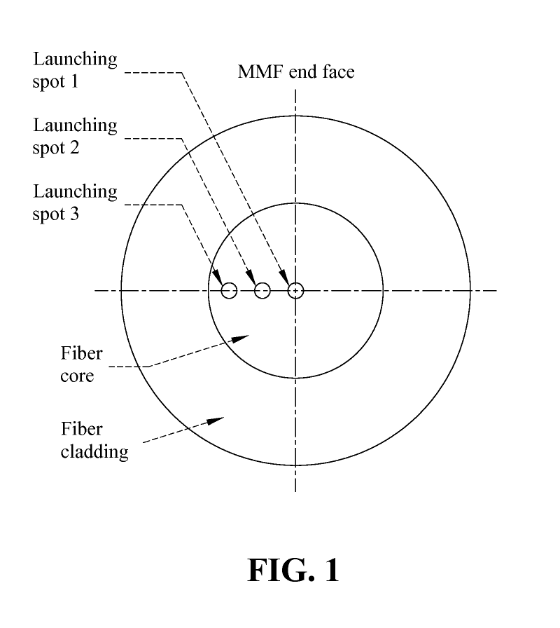

Refer to FIG. 3, the DMD measurement system may further include a computer 390 installed for controlling the pigtail 340 in linear movement at specific step to make measurements at spots of starting at the axis of the fiber core and moving outward to the core/cladding interface as shown in FIG. 1. Also the computer 390 may also connect the digital oscilloscope 380 for recording data from the digital oscilloscope 380 to evaluate DMD. Furthermore, the DMD measurement system may be covered in hermetical box (such as dash line in FIG. 3) which improves system stability.

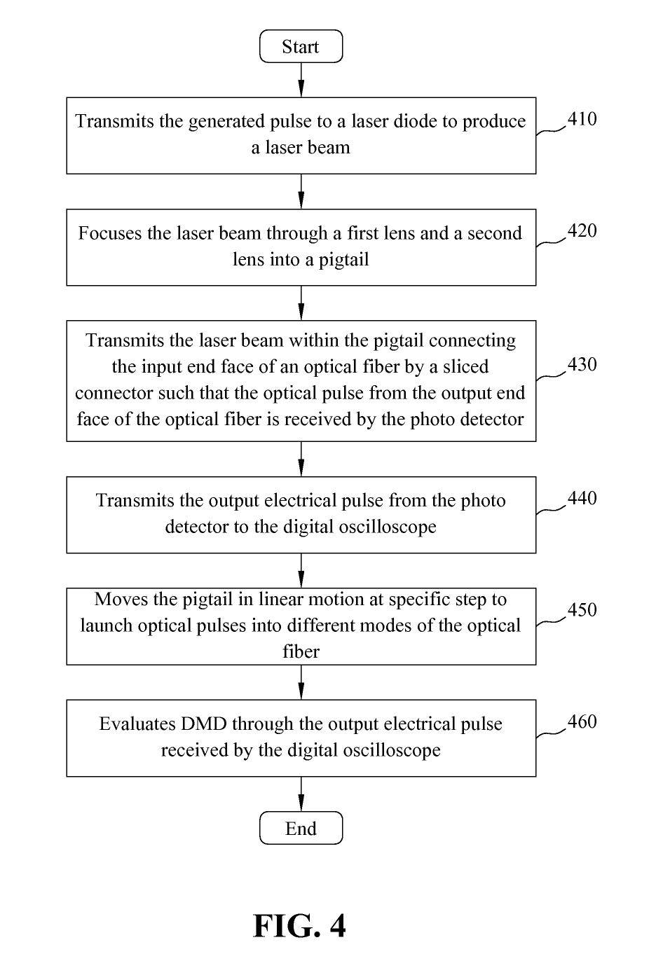

According to another exemplary embodiment, FIG. 4 illustrates a schematic diagram of a method for measuring DMD. The method for measuring differential mode delay may use a pulse generator to generate an input electrical pulse, and a digital oscilloscope to receive an output electrical pulse from an photo detector, the method includes: transmitting the generated pulse to a laser diode to produce a laser beam (step 410), focusing the laser beam through a first lens and a second lens into a pigtail (step 420), transmitting the laser beam within the pigtail connecting the input end face of an optical fiber by a spliced fiber connector such that the optical pulse from the output end face of the optical fiber is received by the photo diode (step 430), transmitting the output electrical pulse from the photo detector to the digital oscilloscope (step 440), moving the pigtail in linear motion at specific step to launch optical pulses into different modes of the optical fiber (step 450), and evaluating DMD through the output electrical pulse received by the digital oscilloscope (step 460).

As mentioned above, the laser diode used for producing laser beam is such as fiber coupled laser diode or free space type, and the pigtail for receiving focused laser beam may have core size larger than the core size of the optical fiber, and use such as patch cord. Usually the optical fiber is such as a multimode optical fiber, and the optical detector used to receive the optical pulse may use one with fast response time for better DMD measurements. Additionally, the method may further use a computer for controlling the pigtail in linear motion at specific step to make measurements at different spots of the fiber and recording data from the digital oscilloscope to evaluate DMD.

In summary, the exemplary embodiment of technology for measuring differential mode delay (DMD) uses two lenses focusing single launch laser beam into a pigtail to connect a MMF under test through a spliced connector in order to make DMD measurement. In this technology, time-consuming fiber centering procedure may be excluded from routine measurement, high-cost computer-controlled translation stages may be eliminated for each routine measurement, and the DMD measurement system may be covered in hermetical box which improves system stability.

Although the disclosure has been described with reference to the exemplary embodiments. It will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A system for measuring differential mode delay (DMD) coupling with a pulse generator to generate an input electrical pulse, a photo detector to receive optical pulse from an optical fiber, and a digital oscilloscope to receive an output electrical pulse transmitted from said photo detector, the system comprises:
a laser diode, configured to receive the generated pulse to generate a laser beam;
a first lens and a second lens, configured to focus said laser beam;
a pigtail, configured to receive said focused laser beam; and
a spliced optical connector, configured to connect said pigtail and the input end face of said optical fiber such that said optical pulse from the output end face of said optical fiber is received by said photo detector.

2. The system as claimed in claim 1, wherein said optical fiber is a multimode fiber (MMF).

3. The system as claimed in claim 1, wherein said laser diode is a fiber coupled laser diode or free space type.

4. The system as claimed in claim 1, wherein said pigtail is a patch cord.

5. The system as claimed in claim 1, wherein either one of said first lens and said second lens moves to adjust the distance between said first lens and said second lens.

6. The system as claimed in claim 1, wherein said pigtail is movable to be preliminary centered on said input end face of said optical fiber.

7. The system as claimed in claim 1, wherein the core size of said pigtail is larger than the core size of said optical fiber.

8. The system as claimed in claim 1, said system further comprises a computer, said computer controls said pigtail in linear motion at specific steps to make measurements at different spots of said optical fiber.

9. The system as claimed in claim 1, said system further comprises a computer, said computer records data from said digital oscilloscope to evaluate DMD.

10. The system as claimed in claim 1, wherein said system is covered in a hermetical box.

11. A method for measuring differential mode delay (DMD) using a pulse generator to generate an input electrical pulse, and a digital oscilloscope to receive an output electrical pulse from a photo detector, the method comprises:
transmitting said generated pulse to a laser diode to generate a laser beam;
focusing said laser beam through a first lens and a second lens into a pigtail;
transmitting said laser beam within said pigtail connecting the input end face of an optical fiber by a spliced fiber connector such that said optical pulse from the output end face of said optical fiber is received by said photo detector;
transmitting the output electrical pulse from the photo detector to the digital oscilloscope;
moving said pigtail in linear motion at specific step to launch optical pulses into different modes of said optical fiber; and
evaluating DMD through said output electrical pulse received by said digital oscilloscope.

12. The method as claimed in claim 11, wherein said optical fiber is a multimode fiber (MMF).

13. The method as claimed in claim 11, wherein said laser diode is a fiber coupled laser diode or free space type.

14. The method as claimed in claim 11, wherein said pigtail is a patch cord.

15. The method as claimed in claim 11, said method moves either one of said first lens and said second lens to adjust the distance between said first lens and said second lens.

16. The method as claimed in claim 11, said method moves said pigtail to be preliminary centered on said input end face of said optical fiber.

17. The method as claimed in claim 11, wherein the core size of said pigtail is larger than the core size of said optical fiber.

18. The method as claimed in claim 11, said method further uses a computer to control said pigtail in linear motion at specific step to make measurements at different spots of said optical fiber.

19. The method as claimed in claim 11, said method further uses a computer for recording data from said digital oscilloscope to evaluate DMD.
